(19) United States
(12) Patent Application Publication
(10) Pub. No.: US 2026/0024278 A1
(43) Pub. Date: Jan. 22, 2026

(54) GENERATING CONSISTENT OBJECT VIEWS USING UNSUPERVISED FINE-TUNING

(71) Applicant: ADOBE INC., SAN JOSE, CA (US)

(72) Inventors: Desai Xie, Westbury, NY (US); Jiahao Li, Chicago, IL (US); Hao Tan, Santa Clara, CA (US); Xin Sun, Palo Alto, CA (US); Zhixin Shu, San Jose, CA (US); Yi Zhou, San Jose, CA (US); Sai Bi, San Jose, CA (US)

(21) Appl. No.: 18/777,072

(22) Filed: Jul. 18, 2024

(51) Int. Cl. G06T 17/00; G06T 5/50; G06T 7/194; G06T 11/00; G06T 13/40

(52) U.S. Cl. CPC G06T 17/00; G06T 5/50; G06T 7/194; G06T 11/00; G06T 13/40; G06T 2207/20221

(57) ABSTRACT

A method, apparatus, non-transitory computer readable medium, and system for image generation image generation may include obtaining a first image depicting a first view of an object, generating a second image depicting a second view of the object based on the first image, and generating a third image depicting a third view of the object based on the first image, where the third view is structurally consistent with the second view.

### BACKGROUND

The following relates generally to image processing, and more specifically to finetuning image generation models. Image processing and computer vision focus on how machines can understand, interpret, and interact with visual data. Image processing algorithms range from simple tasks such as image enhancement and noise reduction, to more complex tasks such as object detection, face recognition, semantic segmentation, and image content generation. Image processing forms the foundation for computer vision, enabling machines to mimic human visual perception and interpret the world in a structured and meaningful way.

Image generation is a type of image processing that involves the creation of synthetic images. Recently, generative artificial intelligence (AI) models have been developed to generate realistic images. One such model is the Denoising Diffusion Probabilistic Model (DDPM). DDPMs generate samples by transforming an initial random noise distribution into a data distribution over a series of time steps. In some cases, a DDPM can be conditioned on a text description, such that the diffusion process generates images that match the text.

### SUMMARY

Embodiments of the inventive concepts described herein include systems and methods for generating multiple consistent views of an object. As used herein, “consistent” refers to the similarity in appearance and geometric alignment across different views. Embodiments generate views such that each view faithfully represents the same features and proportions of the object under varying perspectives. Embodiments include an image generation model trained to receive an image of a first view of an object and a transformation instruction as input, and to generate a synthetic image of a second view of the object, wherein the second view depicts the transformation. The transformation instruction may be, for example, one or more desired rotations of the object. Embodiments train the image generation model by generating multiple synthetic views of an input image, constructing a 3D representation of the object of the input image using the synthetic views, re-rendering the same views using the constructed 3D representation, computing a similarity loss based on differences between the synthetic views and re-rendered views, and updating parameters of the image generation model based on the similarity loss.

A method, apparatus, non-transitory computer readable medium, and system for generating consistent views of an object are described. One or more aspects of the method, apparatus, non-transitory computer readable medium, and system include obtaining a first image depicting a first view of an object; generating, using an image generation model, a second image depicting a second view of the object based on the first image; and generating, using the image generation model, a third image depicting a third view of the object based on the first image, wherein the third view is structurally consistent with the second view.

A method, apparatus, non-transitory computer readable medium, and system for finetuning image generation models are described. One or more aspects of the method, apparatus, non-transitory computer readable medium, and system include obtaining a training set including a training image depicting a first view of an object; generating a plurality of output images based on the training image, wherein the plurality of output images depict a plurality of different views of the object, respectively; generating a three-dimensional (3D) model based on the plurality of output images; and training, using the training set and the 3D model, an image generation model to generate a synthetic image depicting a second view of the object, wherein the image generation model is trained using unsupervised learning by computing a reward based on the 3D model.

A method, apparatus, non-transitory computer readable medium, and system for finetuning image generation models are described. One or more aspects of the method, apparatus, non-transitory computer readable medium, and system include obtaining a training set including a training image depicting a first view of an object; generating an output image depicting a second view of the object based on the training image; generating a three-dimensional (3D) model based on the output image and the training image; and training, using the 3D model, an image generation model to generate a synthetic image depicting a third view of the object.

An apparatus, system, and method for finetuning image generation models are described. One or more aspects of the apparatus, system, and method include at least one processor; at least one memory storing instructions executable by the at least one processor; and an image generation model comprising parameters stored in the at least one memory, wherein the image generation model is trained to generate a synthetic image depicting a second view of an object based on an input image depicting a first view of the object, wherein the image generation model is trained using unsupervised learning by generating a three-dimensional (3D) model based on an output image of the image generation model and computing a reward based on the 3D model.

### BRIEF DESCRIPTION OF THE DRAWINGS

FIG. 1 shows an example of an image processing system according to aspects of the present disclosure.

FIG. 2 shows an example of an image processing apparatus according to aspects of the present disclosure.

FIG. 3 shows an example of an image generation model according to aspects of the present disclosure.

FIG. 4 shows an example of a 3D modeling component and a rendering component according to aspects of the present disclosure.

FIG. 5 shows an example of a view generation pipeline according to aspects of the present disclosure.

FIG. 6 shows an example of a method for generating first and second views of an object according to aspects of the present disclosure.

FIG. 7 shows an example of a training pipeline according to aspects of the present disclosure.

FIG. 8 shows an example of a method for training a machine learning model according to aspects of the present disclosure.

FIG. 9 shows an example of a computing device according to aspects of the present disclosure.

### DETAILED DESCRIPTION

Image generation is frequently used in creative workflows. Historically, users would rely on manual techniques and drawing software to create visual content. The advent of machine learning (ML) has enabled new workflows that automate the image creation process. ML is a field of data processing that focuses on building algorithms capable of learning from and making predictions or decisions based on data. It includes a variety of techniques, ranging from simple linear regression to complex neural networks, and plays a significant role in automating and optimizing tasks that would otherwise require extensive human intervention.

Generative models in ML are algorithms designed to generate new data samples that resemble a given dataset. Generative models are used in various fields, including image generation. They work by learning patterns, features, and distributions from a dataset and then using this understanding to produce new, original outputs.

Recent advances in generative models, such as the Denoising Diffusion Probabilistic Model (DDPM), have enabled the generation of arbitrary objects based on text prompts. DDPMs iteratively refine noise into structured images, where the refinement can be conditioned on text features such as an encoding of the text prompt.

In some cases, generative models are trained in a supervised fashion based on ground-truth data. For example, some systems are trained in a supervised fashion with curated 3D model data to synthesize new views of an object based on an input camera perspective. In some cases, these synthesized views can be used to construct a 3D representation of the object, such as a Neural Radiance Field (NeRF) representation.

However, challenges still persist in ensuring the consistency of generated images. For example, some object generation systems produce views that can exhibit discrepancies in object features such as color and structural details, especially when they are prompted to generate objects outside of their training domain. The resulting reconstructed 3D models, as a result, can suffer from oversmoothed surfaces and floating artifacts.

Embodiments improve the accuracy of existing image generation systems by increasing the consistency between synthesized views of objects. For example, given an image of an object, embodiments are capable of generating images of new views of the object, where the new views maintain the same structural and color aspects of the object across the views. Embodiments of the present disclosure include an image generation model configured to generate new views of an object based on an input image of the object and a camera transformation instruction, where the synthesized views of the object are consistent with the input image. Embodiments of the image generation model are fine-tuned through an unsupervised reinforcement learning process that includes: generating multiple views of an object using the image generation model, forming a 3D model from these views via a 3D modeling component, obtaining rendered views of the 3D model that correspond to the generated views, and adjusting the parameters of the image generation model to align its output with the renderings from the 3D model.

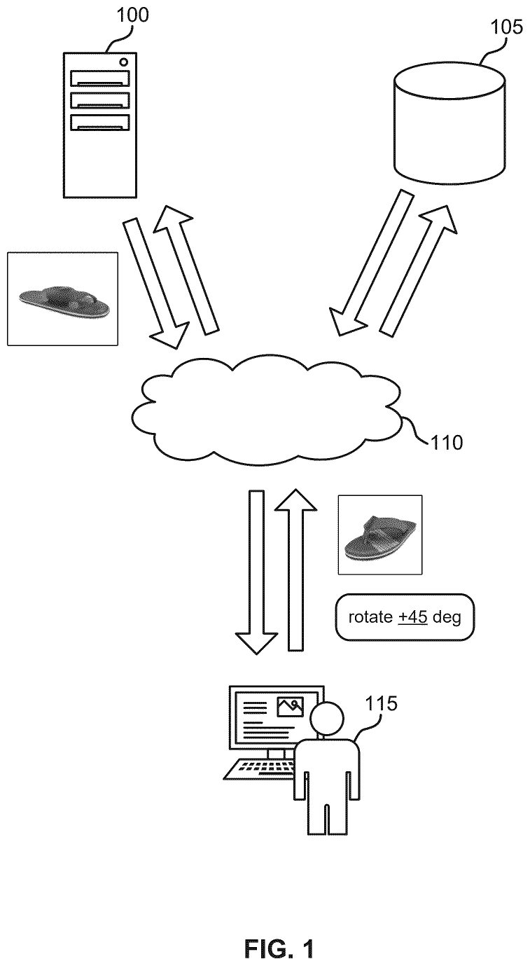

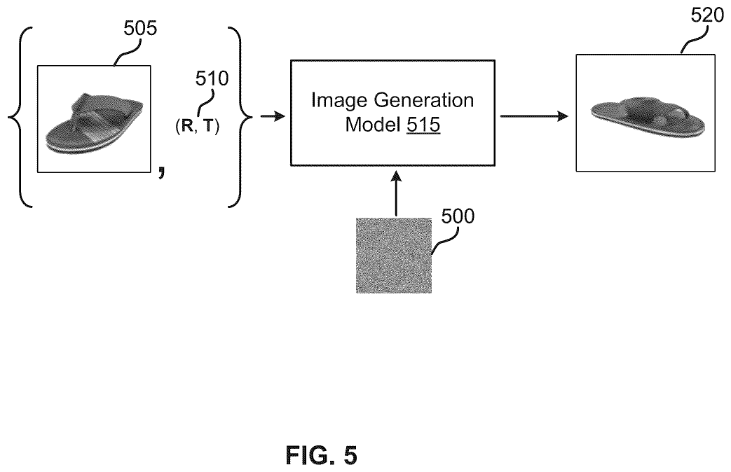

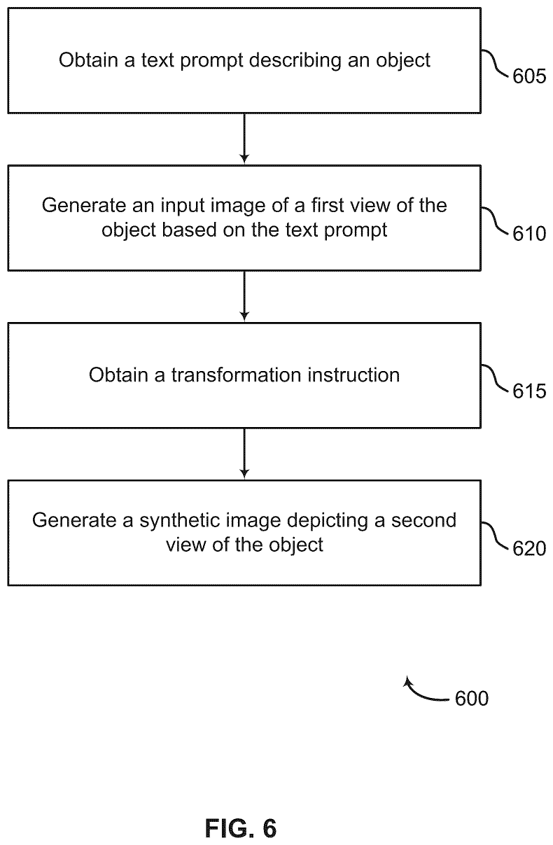

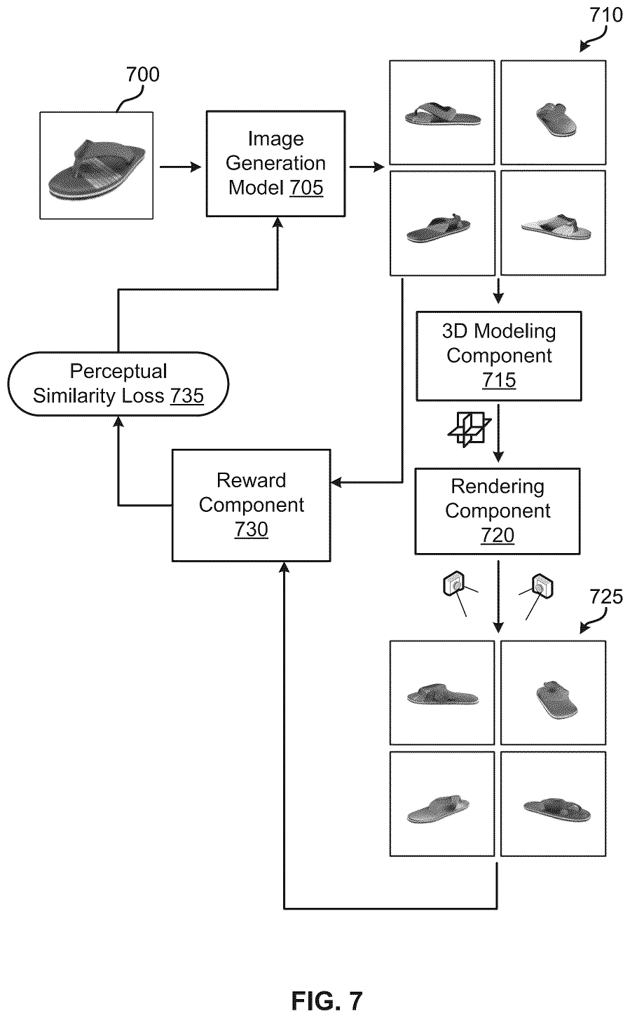

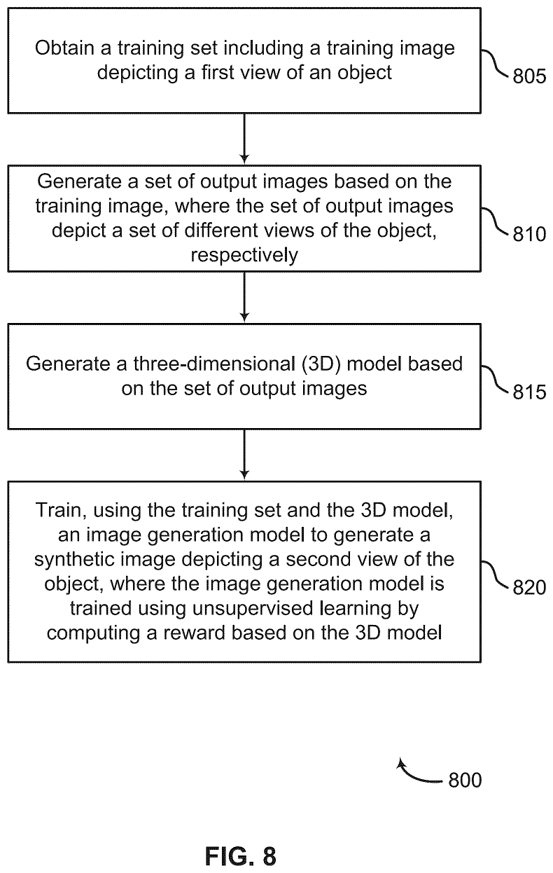

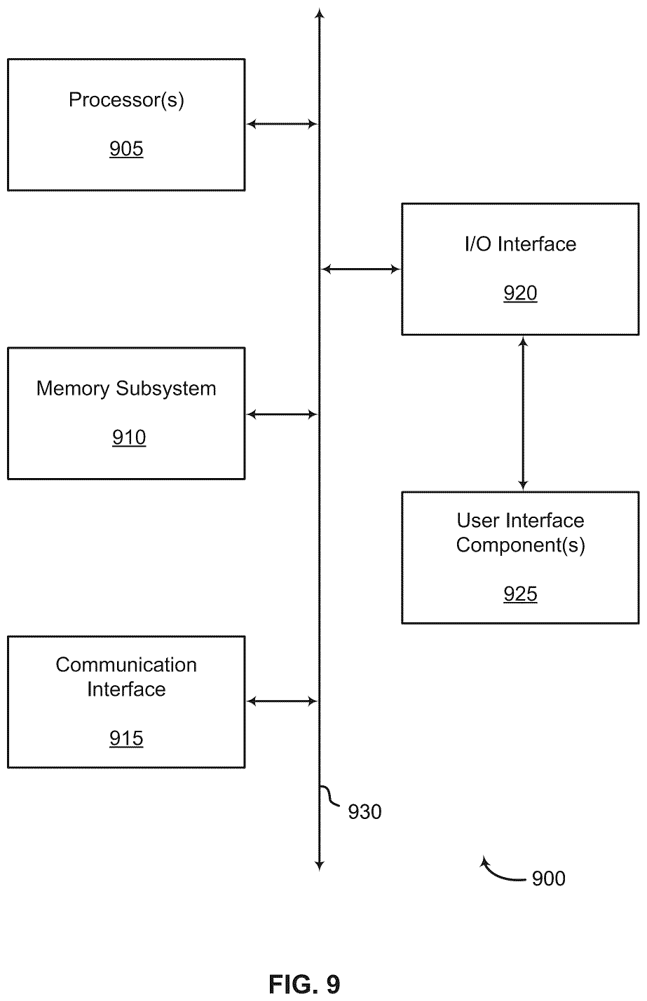

An image processing system is described with reference to FIGS. 1-4. Methods for generating images, including multiple views of an object, are described with reference to FIGS. 5-6. Methods for training an image generation model are described with reference to FIGS. 7-8. A computing device configured to implement an image processing apparatus is described with reference to FIG. 9.

### Image Processing System

An apparatus for finetuning image generation models is described. One or more aspects of the apparatus include at least one processor; at least one memory storing instructions executable by the at least one processor; and an image generation model comprising parameters stored in the at least one memory, wherein the image generation model is trained to generate a synthetic image depicting a second view of an object based on an input image depicting a first view of the object, wherein the image generation model is trained using unsupervised learning by generating a three-dimensional (3D) model based on an output image of the image generation model and computing a reward based on the 3D model.

Some examples of the apparatus, system, and method further include a 3D modeling component configured to generate the 3D model. Some examples further include a rendering component configured to generate images based on the 3D model. Some examples further include a reward component configured to compute the reward. In some aspects, the image generation model comprises a diffusion model.

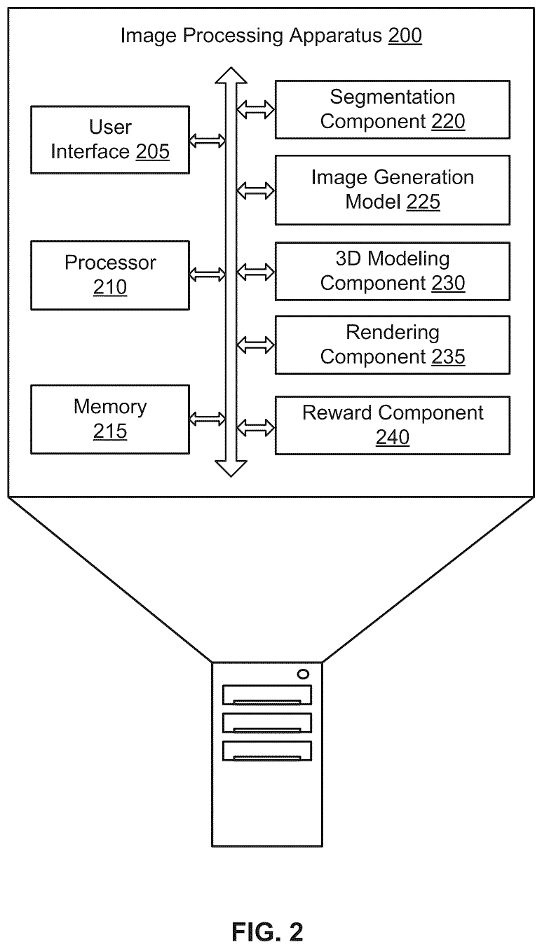

FIG. 1 shows an example of an image processing system according to aspects of the present disclosure. The example shown includes image processing apparatus 100, database 105, network 110, and user 115. Image processing apparatus 100 is an example of, or includes aspects of, the corresponding element described with reference to FIG. 2.

In an example use case, user 115 provides an input image depicting a first view of an object, and a transformation instruction. The transformation instruction may be, for example, an instruction to rotate the object about one or more axes by a certain amount. Then, image processing apparatus 100 generates a synthetic image depicting the object after applying the transformation. According to some aspects, the synthetic image is consistent with the input image. For example, the synthetic image depicts the same object from the input image, with the same coloring and the same structural features.

In some embodiments, one or more components of image processing apparatus 100 are implemented on a server. A server provides one or more functions to users linked by way of one or more various networks, such as network 110. In some cases, the server includes a single microprocessor board, which includes a microprocessor responsible for controlling all aspects of the server. In some cases, a server uses microprocessor and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) may also be used. In some cases, a server is configured to send and receive hypertext markup language (HTML) formatted files (e.g., for displaying web pages). In various embodiments, a server comprises a general-purpose computing device, a personal computer, a laptop computer, a mainframe computer, a super computer, or any other suitable processing apparatus.

Database 105 stores information used by image processing apparatus 100, such as machine learning model parameters, training data, generated images, and the like. A database is an organized collection of data. For example, database 105 stores data in a specified format known as a schema. A database may be structured as a single database, a distributed database, multiple distributed databases, or an emergency backup database. In some cases, a database controller may manage data storage and processing in database 105. In some cases, user 115 interacts with a database controller. In other cases, the database controller may operate automatically without user interaction.

Network 110 facilitates the transfer of information between the image processing apparatus 100, database 105, and user 115. In some cases, network 110 is referred to as a “cloud.” A cloud is a computer network configured to provide on-demand availability of computer system resources, such as data storage and computing power. In some examples, the cloud provides resources without active management by user 115. The term cloud is sometimes used to describe data centers available to many users over the Internet. Some large cloud networks have functions distributed over multiple locations from central servers. A server is designated an edge server if it has a direct or close connection to a user, such as user 115. In some cases, a cloud is limited to a single organization. In other examples, the cloud is available to many organizations. In one example, a cloud includes a multi-layer communications network comprising multiple edge routers and core routers. In another example, a cloud is based on a local collection of switches in a single physical location.

FIG. 2 shows an example of an image processing apparatus 200 according to aspects of the present disclosure. The example shown includes image processing apparatus 200, user interface 205, processor 210, memory 215, segmentation component 220, image generation model 225, 3D modeling component 230, rendering component 235, and reward component 240.

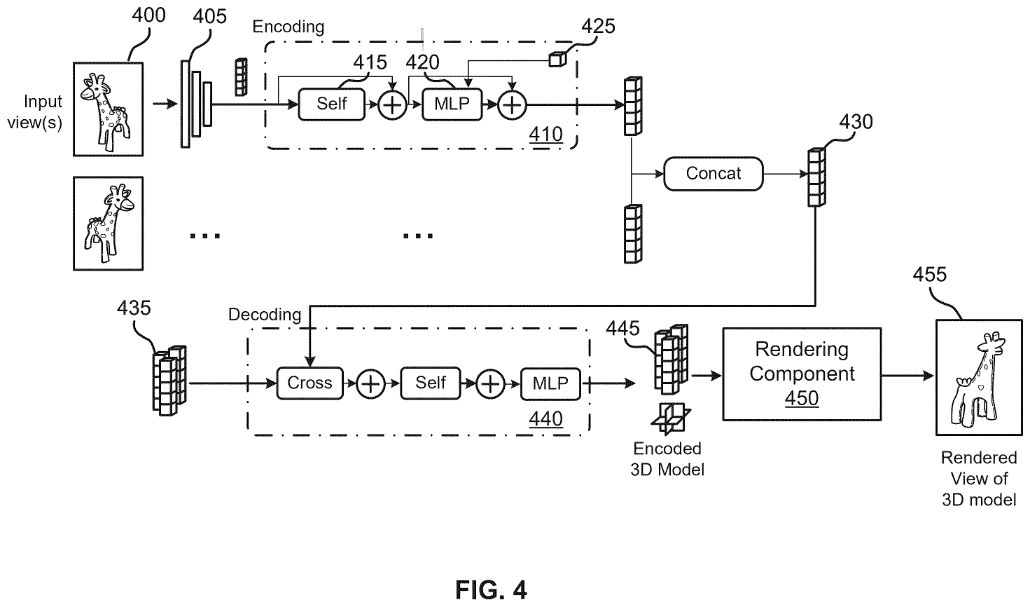

Image processing apparatus 200 is an example of, or includes aspects of, the corresponding element described with reference to FIG. 1. Image generation model 225 is an example of, or includes aspects of, the corresponding element described with reference to FIGS. 5 and 7. 3D modeling component 230 is an example of, or includes aspects of, the corresponding element described with reference to FIG. 7. Rendering component 235 is an example of, or includes aspects of, the corresponding element described with reference to FIGS. 4 and 7. Reward component 240 is an example of, or includes aspects of, the corresponding element described with reference to FIG. 7.

A user interface 205 enables a user to interact with a device. In some embodiments, the user interface 205 includes an audio device, such as an external speaker system, an external display device such as a display screen, or an input device (e.g., remote control device interfaced with the user interface 205 directly or through an IO controller module). In some cases, a user interface 205 may be a graphical user interface 205 (GUI). According to some aspects, a user may upload an image of an object as well as specify a transformation instruction using user interface 205. For example, a user may select or type in one or more angle(s) by which to rotate the object depicted in the image.

A processor 210 is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof). In some cases, processor 210 is configured to operate a memory array using a memory controller. In other cases, a memory controller is integrated into processor 210. In some cases, processor 210 is configured to execute computer-readable instructions stored in memory 215 to perform various functions. The components of image processing apparatus 200 may be implemented as sets of such instructions or may be implemented in their own dedicated circuits. In some embodiments, processor 210 includes special purpose components for modem processing, baseband processing, digital signal processing, or transmission processing.

Memory 215 stores information used by image processing apparatus 200, such as computer-readable instructions and machine learning parameters. Examples of a memory device include random access memory (RAM), read-only memory (ROM), or a hard disk. Examples of memory devices include solid state memory and a hard disk drive. In some examples, memory 215 is used to store computer-readable, computer-executable software including instructions that, when executed, cause processor 210 to perform various functions described herein. In some cases, the memory 215 contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within memory 215 store information in the form of a logical state.

Segmentation component 220 is configured to perform image segmentation on an image. In digital image processing and computer vision, image segmentation is the process of partitioning a digital image into multiple segments (sets of pixels, also known as image objects). The goal of segmentation is to simplify and/or change the representation of an image into something that is more meaningful and easier to analyze. Image segmentation is typically used to locate objects and boundaries (lines, curves, etc.) in images. More precisely, image segmentation is the process of assigning a label to every pixel in an image such that pixels with the same label share certain characteristics. Embodiments of segmentation component 220 perform rule-based or machine learning (ML) computer vision techniques.

In an embodiment, segmentation component 220 performs image segmentation to identify pixels corresponding to a background region. For example, an image generation model may generate an image of an object with a non-white background. In some cases, having a background that is not white or not a solid color may impede the functionality of the image generation model 225 to generate new views of the object, or may impede the functionality of the 3D modeling component 230 to construct a 3D representation of the object. Segmentation component 220 may identify the pixels of the background region and replace the pixels with a solid color, such as white, before the image is used to synthesize new views or 3D models. This process is sometimes referred to as “masking.”

Some components of image processing apparatus 200, such as image generation model 225 and 3D modeling component 230, may include an artificial neural network (ANN) architecture. An ANN is a hardware or a software component that includes a number of connected nodes (i.e., artificial neurons), which loosely correspond to the neurons in a human brain. Each connection, or edge, transmits a signal from one node to another (like the physical synapses in a brain). When a node receives a signal, it processes the signal and then transmits the processed signal to other connected nodes. In some cases, the signals between nodes comprise real numbers, and the output of each node is computed by a function of the sum of its inputs. In some examples, nodes may determine their output using other mathematical algorithms (e.g., selecting the max from the inputs as the output) or any other suitable algorithm for activating the node. Each node and edge is associated with one or more node weights that determine how the signal is processed and transmitted.

During the training process, these weights are adjusted to improve the accuracy of the result (i.e., by minimizing a loss function which corresponds in some way to the difference between the current result and the target result). The weight of an edge increases or decreases the strength of the signal transmitted between nodes. In some cases, nodes have a threshold below which a signal is not transmitted at all. In some examples, the nodes are aggregated into layers. Different layers perform different transformations on their inputs. The initial layer is known as the input layer and the last layer is known as the output layer. In some cases, signals traverse certain layers multiple times.

Image generation model 225 is configured to generate an image based on conditional guidance. For example, image generation model 225 may receive an input image of an object and a transformation instruction, encode the input image and the transformation instruction to generate guidance features, and then perform a reverse diffusion process that is conditioned by the guidance features to generate a synthetic image that depicts a different view of the object, e.g., a different view corresponding to the transformation instruction. In some embodiments, the input image is first generated by image generation model 225 from a text prompt describing the object.

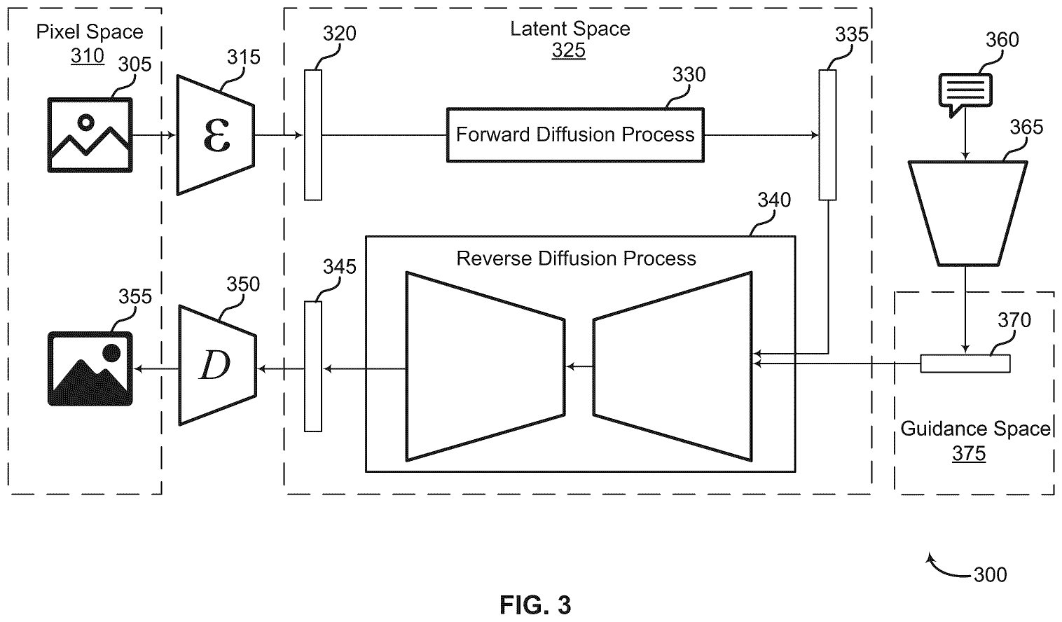

According to some aspects, image generation model 225 generates, using an image generation model 225, a synthetic image depicting a second view of the object, where the image generation model 225 is trained using unsupervised learning by generating a three-dimensional (3D) model based on an output image of the image generation model 225 and computing a reward based on the 3D model. In some examples, image generation model 225 generates a set of synthetic images depicting a set of views of the object, where the set of views are structurally consistent with each other. In some examples, image generation model 225 generates the input image based on the text prompt. According to some aspects, image generation model 225 generates a set of output images depicting a set of views of the object. Embodiments of image generation model 225 include a diffusion model. Additional detail regarding the diffusion model is provided with reference to FIG. 3.

3D modeling component 230 is configured to generate a 3D model of an object based on one or more input image(s) of the object. In some cases, a 3D model uses vertex or mesh data to explicitly define the shape of an object. In the present embodiments, the 3D model may be stored in an encoded form, such as a NeRF representation or as triplane tokens. Neural Radiance Fields (NeRF) and triplane tokens are techniques used to represent 3D models in computational imaging. NeRF utilizes a neural network to encode a volumetric scene, simulating how light travels through space and interacts with surfaces to produce highly realistic images from any viewpoint. A NeRF representation of an object models the color and density of points in a 3D space, which are used to render images with complex details and view-dependent effects. Triplane tokens simplify the representation of 3D spaces by projecting a version of the scene onto three orthogonal 2D planes-corresponding to XY, XZ, and YZ axes. These planes store encoded features that, when decoded, reconstruct the 3D properties such as color and density. This approach reduces computational requirements by transforming a 3D decoding problem into a combination of 2D tasks. Embodiments of 3D modeling component 230 utilize convolutional neural network (CNN)-based and transformer-based encoders to generate 2D image features, and then map these features onto triplane tokens in a decoding process to generate a 3D representation of an object.

A convolutional neural network (CNN) is a class of neural network that is commonly used in computer vision or image classification systems. In some cases, a CNN may enable processing of digital images with minimal pre-processing. A CNN may be characterized by the use of convolutional (or cross-correlational) hidden layers. These layers apply a convolution operation to the input before signaling the result to the next layer. Each convolutional node may process data for a limited field of input (i.e., the receptive field). During a forward pass of the CNN, filters at each layer may be convolved across the input volume, computing the dot product between the filter and the input. During the training process, the filters may be modified so that they activate when they detect a particular feature within the input.

Embodiments of 3D modeling component 230 include transformer-based components. A transformer or transformer network is a type of neural network model used for natural language processing tasks. A transformer network transforms one sequence into another sequence using an encoder and a decoder. Encoder and decoder include modules that can be stacked on top of each other multiple times. The modules comprise multi-head attention and feed forward layers. The inputs and outputs (target sentences) are first embedded into an n-dimensional space. Positional encoding of the different words (i.e., give every word/part in a sequence a relative position since the sequence depends on the order of its elements) are added to the embedded representation (n-dimensional vector) of each word. In some examples, a transformer network includes an attention mechanism, where the attention looks at an input sequence and decides at each step which other parts of the sequence are important. The attention mechanism involves query, keys, and values denoted by Q, K, and V, respectively. Q is a matrix that contains the query (vector representation of one word in the sequence), K are all the keys (vector representations of all the words in the sequence) and V are the values, which are again the vector representations of all the words in the sequence. For the encoder and decoder, multi-head attention modules, V consists of the same word sequence than Q. However, for the attention module that is taking into account the encoder and the decoder sequences, V is different from the sequence represented by Q. In some cases, values in V are multiplied and summed with some attention-weights a.

Embodiments of 3D modeling component 230 include a vision transformer such as DINO (self-Distillation with NO labels). A vision transformer (e.g., a ViT model) is a neural network model configured for computer vision tasks. Unlike CNNs, ViTs use a transformer architecture, which was originally developed for natural language processing (NLP) tasks. ViTs break down an input image into a sequence of patches, which are then fed through a series of transformer encoder layers. The output of the final encoder layer is fed into a multi-layer perceptron (MLP) head for classification. ViTs can capture long-range dependencies between patches without relying on spatial relationships.

The 3D modeling component 230 may further include one or more multi-layer perceptron (MLP) components in its encoder and decoder components. An MLP is a feed forward neural network that typically includes multiple layers of perceptrons. Each component perceptron layer may include an input layer, one or more hidden layers, and an output layer. Each node may include a nonlinear activation function. An MLP may be trained using backpropagation (i.e., computing the gradient of the loss function with respect to the parameters). Additional detail regarding the 3D modeling component 230 is provided with reference to FIG. 4.

Rendering component 235 is configured to process a 3D representation/model of an object to render views of the object. The 3D representation or model may be an MLP such as a NeRF model, an encoded representation such as triplane tokens, explicit information such as mesh, vertex, or other shape data, or some combination thereof. Rendering component 235 may perform a volumetric rendering operation to produce pixel images of the views of the object.

Volumetric rendering is a computational technique used to create visual representations of three-dimensional objects from data that describes these objects in volumetric form. This process involves converting the encoded 3D information-such as that from a Multi-Layer Perceptron (MLP) used in Neural Radiance Fields (NeRF) or triplane tokens-into a 2D image that can be viewed on screens. Volumetric rendering is a simulation of how light interacts with materials in a virtual 3D space. As light passes through the volume, it accumulates color and intensity based on the material properties and densities encountered, which are provided by the MLP or decoded from the triplane tokens. This technique allows for the detailed rendering of complex visual effects like shadows, light scattering, and perspective, transforming a mathematical 3D representation into a realistic or stylized visual output.

Reward component 240 computes a reward for use in the training (e.g., an additional training phase other than a large-scale pretraining phase, sometimes referred to herein as “finetuning”) phase. Reward component 240 may compute a similarity loss that quantifies the differences between the views of an object generated by image generation model 225 and the views of the object rendered from a 3D model of the object. According to some aspects, the “reward” in the unsupervised reinforcement learning process is set as the negative value of the similarity loss.

Perceptual similarity loss, for example, LPIPS (Learned Perceptual Image Patch Similarity), is a metric used to assess the likeness between two images based on human visual perception, rather than focusing solely on pixel accuracy. This approach utilizes deep learning features extracted from images that have been processed by some encoder model, such as a CNN. Features from deeper layers of the encoder model capture complex perceptual and semantic information that aligns more closely with how humans perceive images. By measuring the distance between these deep feature representations of two images, perceptual similarity loss quantifies their visual dissimilarity.

According to some aspects, reward component 240 trains, using a training set, an image generation model 225 to generate a synthetic image depicting a second view of the object, where the image generation model 225 is trained using unsupervised learning by generating a three-dimensional (3D) model based on an output image of the image generation model 225 and computing a reward based on the 3D model. In some aspects, the reward is a negative similarity loss. In some examples, reward component 240 compares the target image with the output image, where the reward is based on the comparison. In some examples, reward component 240 computes a set of rewards corresponding to the set of output images. In some aspects, the reward is based on a perceptual similarity metric. In some aspects, the training includes reinforcement learning (RL). In some aspects, the RL includes a Denoising Diffusion Policy Optimization (DDPO).

FIG. 3 shows an example of an image generation model according to aspects of the present disclosure. The example shown includes guided latent diffusion model 300, original image 305, pixel space 310, image encoder 315, original image features 320, latent space 325, forward diffusion process 330, noisy features 335, reverse diffusion process 340, denoised image features 345, image decoder 350, output image 355, text prompt 360, text encoder 365, guidance features 370, and guidance space 375.

In some examples, diffusion models are based on a neural network architecture known as a U-Net. The U-Net takes input features having an initial resolution and an initial number of channels and processes the input features using an initial neural network layer (e.g., a convolutional network layer) to produce intermediate features. The intermediate features are then down-sampled using a down-sampling layer such that down-sampled features have a resolution less than the initial resolution and a number of channels greater than the initial number of channels.

This process is repeated multiple times, and then the process is reversed. That is, the down-sampled features are up-sampled using up-sampling process to obtain up-sampled features. The up-sampled features can be combined with intermediate features having the same resolution and number of channels via a skip connection. These inputs are processed using a final neural network layer to produce output features. In some cases, the output features have the same resolution as the initial resolution and the same number of channels as the initial number of channels.

In some cases, a U-Net takes additional input features to produce conditionally generated output. For example, the additional input features could include a vector representation of an input prompt. The additional input features can be combined with the intermediate features within the neural network at one or more layers. For example, a cross-attention module can be used to combine the additional input features and the intermediate features.

A diffusion process may also be modified based on conditional guidance. In some cases, a user provides a text prompt describing content to be included in a generated image. For example, a user may provide the prompt “a person playing with a cat”. In some examples, guidance can be provided in a form other than text, such as via an image, a sketch, or a layout. The system converts the text prompt (or other guidance) into a conditional guidance vector or other multi-dimensional representation. For example, text may be converted into a vector or a series of vectors using a transformer model, or a multi-modal encoder. In some cases, the encoder for the conditional guidance is trained independently of the diffusion model. In the present embodiments, the conditional guidance may include an encoding of an input image depicting a first view of the object, as well as camera features that describe a transformation—such as a rotation—to be applied to the object and depicted in the generated image.

A noise map is initialized that includes random noise. The noise map may be in a pixel space or a latent space. By initializing an image with random noise, different variations of an image including the content described by the conditional guidance can be generated. Then, the system generates an image based on the noise map and the conditional guidance vector.

A diffusion process can include both a forward diffusion process for adding noise to an image (or features in a latent space) and a reverse diffusion process for denoising the images (or features) to obtain a denoised image. The forward diffusion process can be represented as q(xₜ|xₜ₋₁), and the reverse diffusion process can be represented as p(xₜ₋₁|xₜ). In some cases, the forward diffusion process is used during training to generate images with successively greater noise, and a neural network is trained to perform the reverse diffusion process (i.e., to successively remove the noise).

In an example forward process for a latent diffusion model, the model maps an observed variable x₀ (either in a pixel space or a latent space) intermediate variables x₁, . . . , x_{T} using a Markov chain. The Markov chain gradually adds Gaussian noise to the data to obtain the approximate posterior q(x_{1:T}|x₀) as the latent variables are passed through a neural network such as a U-Net, where x₁, . . . , x_{T} have the same dimensionality as x₀.

The neural network may be trained to perform the reverse process. During the reverse diffusion process, the model begins with noisy data x_{T}, such as a noisy image and denoises the data to obtain the p(xₜ₋₁|xₜ). At each step t−1, the reverse diffusion process takes xₜ, such as first intermediate image, and t as input. Here, t represents a step in the sequence of transitions associated with different noise levels, The reverse diffusion process outputs xₜ₋₁, such as second intermediate image iteratively until x_{T} is reverted back to x₀, the original image. The reverse process can be represented as:

$${p}_{θ} ( {x}_{t - 1} \vert {x}_{t} ) := N ( {x}_{t - 1} ; {μ}_{θ} ( {x}_{t} , t ) , {Σ}_{θ} ( {x}_{t} , t ) ) \qquad ( 1 )$$

The joint probability of a sequence of samples in the Markov chain can be written as a product of conditionals and the marginal probability:

$${x}_{T} ; {p}_{θ} ( {x}_{0 : T} ) := p ( {x}_{T} ) {\prod }_{t = 1}^{T} {p}_{θ} ( {x}_{t - 1} \vert {x}_{t} ) \qquad ( 2 )$$

where p(x_{T})=N(x_{T}; 0, I) is the pure noise distribution as the reverse process takes the outcome of the forward process, a sample of pure noise, as input and

$${\prod }_{t = 1}^{T} {p}_{θ} ( {x}_{t - 1} \vert {x}_{t} )$$

represents a sequence of Gaussian transitions corresponding to a sequence of addition of Gaussian noise to the sample.

At inference time, observed data x₀ in a pixel space can be mapped into a latent space as input and a generated data \tilde{x} is mapped back into the pixel space from the latent space as output. In some examples, x₀ represents an original input image with low image quality, latent variables x₁, . . . , x_{T} represent noisy images, and x represents the generated image with high image quality.

A diffusion model may be trained using both a forward and a reverse diffusion process. In one example, the user initializes an untrained model. Initialization can include defining the architecture of the model and establishing initial values for the model parameters. In some cases, the initialization can include defining hyper-parameters such as the number of layers, the resolution and channels of each layer blocks, the location of skip connections, and the like.

The system then adds noise to a training image using a forward diffusion process in N stages. In some cases, the forward diffusion process is a fixed process where Gaussian noise is successively added to an image. In latent diffusion models, the Gaussian noise may be successively added to features in a latent space.

At each stage n, starting with stage N, a reverse diffusion process is used to predict the image or image features at stage n−1. For example, the reverse diffusion process can predict the noise that was added by the forward diffusion process, and the predicted noise can be removed from the image to obtain the predicted image. In some cases, an original image is predicted at each stage of the training process.

The training system compares predicted image (or image features) at stage n−1 to an actual image (or image features), such as the image at stage n−1 or the original input image. For example, given observed data x, the diffusion model may be trained to minimize the variational upper bound of the negative log-likelihood −log p_{θ}(x) of the training data. The training system then updates parameters of the model based on the comparison. For example, parameters of a U-Net may be updated using gradient descent. Time-dependent parameters of the Gaussian transitions can also be learned.

FIG. 4 shows an example of a 3D modeling component and a rendering component 450 according to aspects of the present disclosure. The example shown includes input image(s) 400, CNN(s) 405, image encoder(s) 410, 2D tokens 430, learnable triplane tokens 435, image-to-triplane decoder 440, triplane representation of object 445, rendering component 450, and rendered view 455. Rendering component 450 is an example of, or includes aspects of, the corresponding element described with reference to FIGS. 2 and 7.

In one aspect, image encoder(s) includes self-attention 415, MLP 420, and camera features 425. The term ‘self-attention’ refers to a mechanism within machine learning models where representations of the input interact with each other to determine attention weights. Self-attention can be distinguished from other attention models because the attention weights are determined at least in part by the input itself. Additional description of the attention mechanism is provided with reference to FIG. 2. The MLP is a feed-forward ANN that includes learnable parameters.

The 3D modeling component is configured to reconstruct a 3D model from input image(s). The 3D model may be, for example, a NeRF representation. The model may predict a full NeRF model that describes the shape of an object from sparse inputs, such as a few images of the object with known poses. Embodiments of the 3D modeling component include an image encoder, an image-to-triplane decoder, and a NeRF decoder. In at least some embodiments, the NeRF decoder is incorporated into rendering component 450, which may be the same as or share aspects with the corresponding element described with reference to FIG. 2.

In this example, input image(s) 400 are input into CNN(s) 405. For example, the number of input images may be 4. In some cases, a shared CNN and image encoder may be used for multiple images. The output of CNN(s) 405, which are latent representations of the input images, are input into encoder(s) 410. According to some aspects, the encoder(s) 410 are based on a pretrained Vision Transformer (ViT) DINO encoder that has been modified to consider camera information in the input. The camera information is camera features 425, which represents a current pose of the camera with respect to the model. The encoding phase produces a set of pose-aware image tokens for each input view. The pose-aware image tokens are concatenated to form 2D tokens 430 as input to the cross-attention component of image-to-triplane decoder 440. The image-to-triplane decoder 440 connects the 2D tokens 430 to learnable triplane tokens 435 using cross-attention, and in the process adjusts the values of learnable triplane tokens 435 to represent the three-dimensional aspects of the input object. Triplane tokens simplify the representation of 3D spaces by projecting a version of the scene onto three orthogonal 2D planes—corresponding to XY, XZ, and YZ axes. These planes store encoded features that, when decoded, reconstruct the 3D properties such as color and density.

After the decoding pipeline, the final output triplane tokens are tokens are re-shaped and upsampled using a de-convolution layer to form the triplane representation of the object 445. Then, rendering component 450 performs simulated ray marching through a bounding box of the object and decodes the triplane features at each point using a shared MLP to determine the density and color of the object at each point. The rendering component 450 then amasses this information across a pixel-ray in the volumetric rendering process to yield each pixel of rendered view 455.

### Generating Consistent Views of Objects

A method for finetuning image generation models is described. One or more aspects of the method include obtaining an input image depicting a first view of an object and generating, using an image generation model, a synthetic image depicting a second view of the object, wherein the image generation model is trained using unsupervised learning by generating a three-dimensional (3D) model based on an output image of the image generation model and computing a reward based on the 3D model.

Some examples of the method, apparatus, non-transitory computer readable medium, and system further include generating a plurality of synthetic images depicting a plurality of views of the object, wherein the plurality of views are structurally consistent with each other. Some examples further include combining the plurality of synthetic images to obtain an animation of the object.

Some examples of the method, apparatus, non-transitory computer readable medium, and system further include generating a model of the object based on the plurality of the synthetic images. Some examples further include obtaining a text prompt. Some examples further include generating the input image based on the text prompt. Some examples further include obtaining a preliminary input image depicting the object and a background region. Some examples further include masking the background region to obtain the input image.

FIG. 5 shows an example of a view generation pipeline according to aspects of the present disclosure. The example shown includes noise sample 500, input image 505, input transformation instruction 510, image generation model 515, and synthetic image 520. Image generation model 515 is an example of, or includes aspects of, the corresponding element described with reference to FIGS. 2 and 7.

In this example, the image generation model 515 conditionally denoises noise sample 500 based on input image 505 and input transformation instruction 510. Input transformation instruction 510 may be specified by a user to instruct the model to generate a new view of an object from input image 505 by applying some transformation to the object, such as one or more rotations. The image generation model 515 may perform a reverse diffusion process as described with reference to FIG. 3 to generate synthetic image 520. According to some aspects, synthetic image 520 is consistent with input image 505. For example, the synthetic image 520 depicts the same object from input image 505, with the same coloring and the same structural features.

FIG. 6 shows an example of a method 600 for generating first and second views of an object according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 605, the system obtains a text prompt describing an object. For example, the text prompt may be “a sandal with blue trim.” In some cases, the operations of this step refer to, or may be performed by, an image processing apparatus as described with reference to FIGS. 1 and 2. For example, a user may input the text prompt via a user interface as described with reference to FIG. 2.

At operation 610, the system generates an input image of a first view of the object based on the text prompt. In some cases, the operations of this step refer to, or may be performed by, an image generation model as described with reference to FIGS. 2, 3, 5, and 7. The image generation model may perform a reverse diffusion process on a noise sample to generate the input image, where the reverse diffusion process is conditioned by an embedding of the text prompt. Given the text prompt above, for example, the image generation model may generate an image of a sandal with blue trim, as viewed from a first camera angle.

At operation 615, the system obtains a transformation instruction. The user may similarly input the transformation instruction via a user interface as described with reference to FIG. 2. For example, the user may indicate the direction(s) in which they wish to rotate and/or otherwise move the object. In some cases, the user may instead select a GUI element labeled, for example, “generate multiple views,” and the system may automatically generate one or more transformation instructions.

At operation 620, the system generates a synthetic image depicting a second view of the object. For example, the system may generate an image of the sandal as viewed from a second camera angle different from the first camera angle. In some cases, the operations of this step refer to, or may be performed by, an image generation model as described with reference to FIGS. 2, 3, 5, and 7. The image generation model may perform a reverse diffusion process on a noise sample to generate the synthetic image, where the reverse diffusion process is conditioned by an embedding of the input image and the transformation instruction. According to some aspects, the system may generate enough views to simulate an animated rotation of the object.

### Training the Machine Learning Model

A method for finetuning image generation models is described. One or more aspects of the method include obtaining a training set including a training image depicting a first view of an object and training, using the training set, an image generation model to generate a synthetic image depicting a second view of the object, wherein the image generation model is trained using unsupervised learning by generating a three-dimensional (3D) model based on an output image of the image generation model and computing a reward based on the 3D model.

Some examples of the method, apparatus, non-transitory computer readable medium, and system further include generating a target image based on the 3D model. Some examples further include comparing the target image with the output image, wherein the reward is based on the comparison. Some examples further include generating a plurality of output images depicting a plurality of views of the object. Some examples further include generating the 3D model based on the plurality of output images. Some examples further include generating a target image based on the 3D model. Some examples further include comparing the target image with a second output image other than the plurality of output images used to generate the 3D model.

Some examples of the method, apparatus, non-transitory computer readable medium, and system further include computing a plurality of rewards corresponding to the plurality of output images. In some aspects, the reward is based on a perceptual similarity metric. In some aspects, the 3D model comprises a Neural Radiance Field (NeRF) model. In some aspects, the training comprises reinforcement learning (RL). In some aspects, the RL comprises a Denoising Diffusion Policy Optimization (DDPO).

FIG. 7 shows an example of a training pipeline according to aspects of the present disclosure. The example shown includes input image 700, image generation model 705, synthetic views 710, 3D modeling component 715, rendering component 720, rendered views 725, reward component 730, and perceptual similarity loss 735.

Image generation model 705 is an example of, or includes aspects of, the corresponding element described with reference to FIGS. 2 and 5. 3D modeling component 715 is an example of, or includes aspects of, the corresponding element described with reference to FIG. 2. Rendering component 720 is an example of, or includes aspects of, the corresponding element described with reference to FIGS. 2 and 4. Reward component 730 is an example of, or includes aspects of, the corresponding element described with reference to FIG. 2.

According to some aspects, when a 3D model such as a NeRF model is reconstructed from input views that are inconsistent, rendered views from the 3D model will contain artifacts such as floaters and blurry edges. Accordingly, embodiments include a training pipeline for finetuning an image generation model to produce novel views of an object that are consistent with each other.

In the example shown, image generation model 705 receives input image 700 and generates a plurality of novel views, e.g. synthetic views 710, therefrom. For example, image generation model 705 uses input image 700 and a transformation instruction selected from a set of pre-determined transformation instructions as conditional information for the generation of each view. Alternatively, the transformation instructions may be computed at the time of training, e.g., based on a determined pose of the object in input image 700. Then, synthetic views 710 are input to a 3D modelling component 715 such as the one described with reference to FIG. 4. The 3D modelling component 715 generates a 3D representation of the object from the input image, and then rendering component 720 renders multiple views of the object (rendered views 725) that depict the same perspectives of the object as synthetic views 710.

Then, reward component 730 computes perceptual similarity loss 735 as a measure of the differences between synthetic views 710 and rendered views 725. An example of the perceptual similarity loss 735 is given by Equation 3:

$$Consistency ( {x}_{1 ... n} , {c}_{1 ... n} ) = \frac{{\sum }_{i}^{n} {d}_{LPIPS} ( {x}_{i} , {f}_{NeRF} ( {x}_{1 ... n} , {c}_{i} ) )}{n} \qquad ( 3 )$$

where c_{1 . . . n} represents the set of n camera transformation instructions corresponding to each image xᵢ, d_{LPIPS} is perceptual distance between the image xᵢ and a rendered view from a NeRF model, and f_{NeRF} represents a NeRF model that takes all generated images x₁, x₂, . . . , xₙ and a specific camera transformation cᵢ, and outputs a rendered image from the perspective cᵢ.

In at least some embodiments, 3D modelling component 715 forms the 3D model using the input image 700 and n−1 images from synthetic views 710 (in this example, 3 images+the input image). Then, the perspective corresponding to the view that was omitted in the 3D reconstruction is rendered by rendering component 720. Subsequently, this rendered view and the view that was omitted in the 3D reconstruction are compared by reward component 730 to compute the perceptual similarity loss 735. This method is sometime referred to as “cross-validation.”

In some embodiments, the perceptual similarity loss 735 is backpropagated through the system to finetune image generation model 705 only. In some embodiments, perceptual similarity loss 735 is backpropagated to update parameters of multiple components of the image processing apparatus. According to some aspects, the negation of perceptual similarity loss 735 is used as a reward function, wherein the finetuning of image generation model 705 follows a Denoising Diffusion Policy Optimization (DDPO) method of training.

FIG. 8 shows an example of a method 800 for training a machine learning model according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 805, the system obtains a training set including a training image depicting a first view of an object. In some cases, the operations of this step refer to, or may be performed by, an image processing apparatus as described with reference to FIGS. 1 and 2. The training set may further include information about the pose of a simulated camera that captures the first view. In some embodiments, the training set further includes a list of object or camera poses. The list may include transformation instructions for the object, such as rotations or movements, and each transformation instruction may have a corresponding camera pose.

At operation 810, the system generates a set of output images based on the training image, where the set of output images depict a set of different views of the object, respectively. In some cases, the operations of this step refer to, or may be performed by, an image generation model as described with reference to FIGS. 2, 5, and 7. For example, the system may generate multiple views of the object by inputting the training image+one of the transformation instructions for each view into the image generation model.

At operation 815, the system generates a three-dimensional (3D) model based on the set of output images. In some cases, the operations of this step refer to, or may be performed by, a 3D modeling component as described with reference to FIGS. 2 and 7. The 3D model may be, but is not necessarily limited to, a Neural Radiance Field (NeRF) model of the object.

At operation 820, the system trains, using the training set and the 3D model, an image generation model to generate a synthetic image depicting a second view of the object, where the image generation model is trained using unsupervised learning by computing a reward based on the 3D model. In some cases, the operations of this step refer to, or may be performed by, a reward component as described with reference to FIGS. 2 and 7. For example, the system may render different views of the constructed 3D model, where the rendered views correspond to the perspectives shown in the views generated by the image generation model. The system may then finetune the image generation model by comparing the differences between the generated views and the rendered views. Additional detail regarding this process is provided with respect to FIG. 7.

In some cases, the training method includes obtaining a training set including a training image depicting a first view of an object; generating an output image depicting a second view of the object based on the training image; generating a 3D model based on the output image and the training image; and training, using the 3D model, an image generation model to generate a synthetic image depicting a third view of the object. The model can be trained to generate arbitrary views of an arbitrary object using a training set that includes a variety of different views and a variety of different objects.

FIG. 9 shows an example of a computing device 900 according to aspects of the present disclosure. The example shown includes computing device 900, processor(s) 905, memory subsystem 910, communication interface 915, I/O interface 920, user interface component(s), and channel 930.

In some embodiments, computing device 900 is an example of, or includes aspects of, image processing apparatus 100 of FIG. 1. In some embodiments, computing device 900 includes one or more processors 905 are configured to execute instructions stored in memory subsystem 910 to obtain an input image depicting a first view of an object; and generate, using an image generation model, a synthetic image depicting a second view of the object, wherein the image generation model is trained using unsupervised learning by generating a three-dimensional (3D) model based on an output image of the image generation model and computing a reward based on the 3D model.

According to some aspects, computing device 900 includes one or more processors 905. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special purpose components for modem processing, baseband processing, digital signal processing, or transmission processing.

According to some aspects, memory subsystem 910 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. The memory may store various parameters of machine learning models used in the components described with reference to FIG. 2. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 915 operates at a boundary between communicating entities (such as computing device 900, one or more user devices, a cloud, and one or more databases) and channel 930 and can record and process communications. In some cases, communication interface 915 is provided to enable a processing system coupled to a transceiver (e.g., a transmitter and/or a receiver). In some examples, the transceiver is configured to transmit (or send) and receive signals for a communications device via an antenna.

According to some aspects, I/O interface 920 is controlled by an I/O controller to manage input and output signals for computing device 900. In some cases, I/O interface 920 manages peripherals not integrated into computing device 900. In some cases, I/O interface 920 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 920 or via hardware components controlled by the I/O controller.

According to some aspects, user interface component(s) 925 enables a user to interact with computing device 900. In some cases, user interface component(s) 925 include an audio device, such as an external speaker system, an external display device such as a display screen, an input device (e.g., a remote-control device interfaced with a user interface directly or through the I/O controller), or a combination thereof. In some cases, user interface component(s) 925 includes a GUI.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method comprising:
obtaining a first image depicting a first view of an object;
generating, using an image generation model, a second image depicting a second view of the object based on the first image; and
generating, using the image generation model, a third image depicting a third view of the object based on the first image, wherein the third view is structurally consistent with the second view.

2. The method of claim 1, wherein:
the image generation model is trained using unsupervised learning by generating a three-dimensional (3D) model based on an output image of the image generation model, computing a reward based on the 3D model, and updating parameters of the image generation model based on the reward.

3. The method of claim 1, further comprising:
combining the second image and the third image to obtain an animation of the object.

4. The method of claim 1, further comprising:
generating a model of the object based on the second image and the third image.

5. The method of claim 1, wherein obtaining the first image comprises:
obtaining a text prompt;
generating the first image based on the text prompt.

6. The method of claim 1, wherein obtaining the first image comprises:
obtaining a preliminary image depicting the object and a background region; and
masking the background region of the preliminary image to obtain the first image.

7. A method of training a machine learning model, the method comprising:
obtaining a training set including a training image depicting a first view of an object;
generating an output image depicting a second view of the object based on the training image;
generating a three-dimensional (3D) model based on the output image and the training image; and
training, using the 3D model, an image generation model to generate a synthetic image depicting a third view of the object.

8. The method of claim 7, wherein training the image generation model comprises:
generating a target image based on the 3D model; and
computing a reward by comparing the target image with the output image, wherein the image generation model is trained based on the reward.

9. The method of claim 8, wherein:
the reward is based on a perceptual similarity metric.

10. The method of claim 7, wherein training the image generation model comprises:
generating a plurality of output images depicting a plurality of views of the object; and
generating the 3D model based on the plurality of output images.

11. The method of claim 10, further comprising:
generating a target image based on the 3D model; and
comparing the target image with a second output image other than the plurality of output images used to generate the 3D model.

12. The method of claim 10, further comprising:
computing a plurality of rewards corresponding to the plurality of output images, wherein the image generation model is trained based on the plurality of rewards.

13. The method of claim 7, wherein:
the 3D model comprises a Neural Radiance Field (NeRF) model.

14. The method of claim 7, wherein:
the training comprises reinforcement learning (RL).

15. The method of claim 14, wherein:
the RL comprises a Denoising Diffusion Policy Optimization (DDPO).

16. An apparatus comprising:
at least one processor;
at least one memory storing instructions executable by the at least one processor; and
the apparatus further comprising an image generation model comprising parameters stored in the at least one memory, wherein the image generation model is trained to generate a synthetic image depicting a second view of an object based on an input image depicting a first view of the object, wherein the image generation model is trained using unsupervised learning by generating a three-dimensional (3D) model based on an output image of the image generation model and computing a reward based on the 3D model.

17. The apparatus of claim 16, further comprising:
a 3D modeling component configured to generate the 3D model.

18. The apparatus of claim 16, further comprising:
a rendering component configured to generate images based on the 3D model.

19. The apparatus of claim 16, wherein:
the image generation model comprises a diffusion model.

20. The apparatus of claim 16, further comprising:
a reward component configured to compute the reward.
